(19) United States
(12) Patent Application Publication
(10) Pub. No.: US 2017/0278113 A1
(43) Pub. Date: Sep. 28, 2017

(54) System for Forecasting Product Sales Using Clustering in Conjunction with Bayesian Modeling

(71) Applicant: DELL PRODUCTS, LP, Round Rock, TX (US)

(72) Inventors: Shibi Panikkar, Bangalore (IN); Sardhendhu Mishra, Sundargarh (IN)

(21) Appl. No.: 15/078,536

(22) Filed: Mar. 23, 2016

(51) Int. Cl. G06Q 30/02; G06F 17/16; G06F 17/30; G06F 17/18

(52) U.S. Cl. CPC G06Q 30/0202; G06F 17/18; G06F 17/16; G06F 17/30598

(57) ABSTRACT

Sales data for existing products may be clustered and then processed by a Bayesian model to extrapolate a sales forecast for a proposed or new product. The output of the Bayesian model may be further processed by regression techniques to extrapolate sales of the proposed or new product over time.

### FIELD OF THE DISCLOSURE

The present disclosure generally relates to information handling systems, and more particularly relates to forecasting product sales using clustering in conjunction with Bayesian modeling.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

Sales data for existing products may be clustered and then processed by a Bayesian model to extrapolate a sales forecast for a proposed or new product. The output of the Bayesian model may be further processed by regression techniques to extrapolate sales of the proposed or new product over time.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a flow diagram of a mechanism of extrapolating a sales forecast, according to an embodiment of the present disclosure;

FIG. 2 is a block diagram illustrating an information handling system, according to an embodiment of the present disclosure;

FIG. 3 is a block diagram of a Bayesian model, according to an embodiment of the present disclosure;

FIG. 4 is a flow diagram illustrating a clustering mechanism for clustering data, according to an embodiment of the present disclosure;

FIG. 5 is a graph of data points, according to an embodiment of the present disclosure;

FIG. 6 is a graph of clusters, according to an embodiment of the present disclosure; and

FIG. 7 is a flow diagram of extrapolating a sales forecast, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

It is desirable to forecast demand for new products or proposed new products. However, accurately forecasting product demand for new products is problematic. Generally, planning teams use product information of related or similar products, such as sales histories of those related products, to forecast product demand for new products or proposed new products. Such a forecast is often not accurate and may be affected by biases of members of the planning team. Furthermore, members of the planning team often override the forecast with their experience with the new or proposed product based on product features and the states of the markets in which the product will be released.

To overcome the deficiencies of existing sales forecasting for products, Bayesian modeling may be used to extrapolate product sales of new or proposed products. More particularly, a Bayesian model may be constructed and used in conjunction with clustering of sales data to provide cluster input to the Bayesian model which will output a sales forecast based upon the cluster input. A Bayesian model is a probabilistic graphical model. A Bayesian model according to embodiments herein may be constructed with nodes representing individual product features connected in a generally forward direction. The Bayesian model may take a cluster of data as input and output a sales forecast for a hypothetical product based upon the cluster input. The output of the Bayesian model may further be refined by regression techniques such as Linear Regression to further refine the sales forecast.

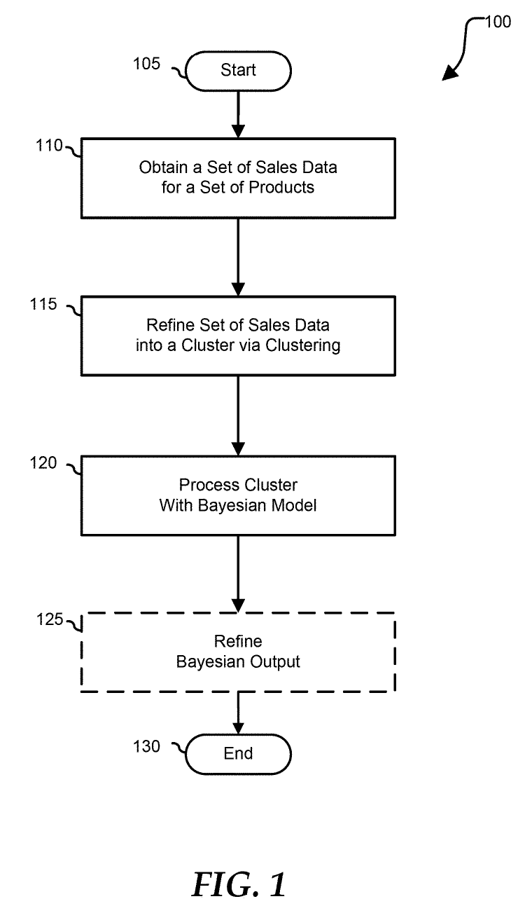

FIG. 1 is a flow diagram 100 illustrating a data processing mechanism that may be executed by an information handling system for extrapolating a sales forecast for a new or proposed product based upon existing sales data for one or more existing products. At 105, the data processing mechanism begins. At 110, a set of sales data for a set of products is obtained. The set of products may be products related to a new or proposed product for which it is desired to extrapolate a sales forecast. For example, if the new or proposed product is a new computer product, the set of products may be existing computer products with one or more similar or common features to the new computer product.

At 115, the set of sales data is refined into a cluster of data points via clustering. At 120, the cluster is processed with the Bayesian model to produce a sales range of extrapolated sales. At 125, the sales range generated by the Bayesian model is refined with regression techniques, for example, Linear regression. The regression techniques may provide a temporal granularity to the sales range. Step 125 may be optional, as indicated by the dashed line in flow diagram 100. At 130, the data processing mechanism ends.

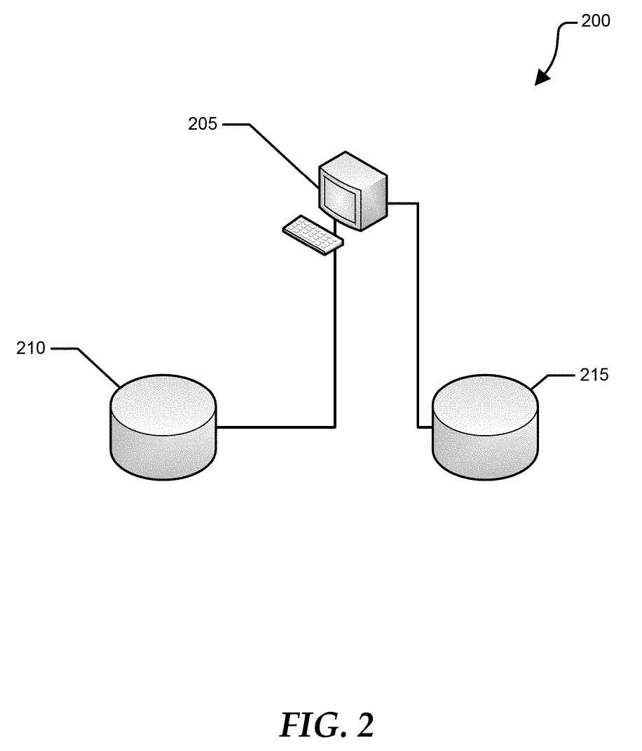

FIG. 2 is a block diagram illustrating an information handling system 200 according to an embodiment of the present disclosure. Information handling system 200 comprises information handling system computer 205 and databases 210 and 215 communicatively coupled to computer 205. Database 210 may store a computer program that may be run on computer 205 to extrapolate sales for a new product using a Bayesian model. Database 215 may store sales information for a set of products with one or more features in common with the new product. Computer 205 may run the computer program in database 210 using sales information from database 215 to extrapolate sales forecasts for new or proposed products.

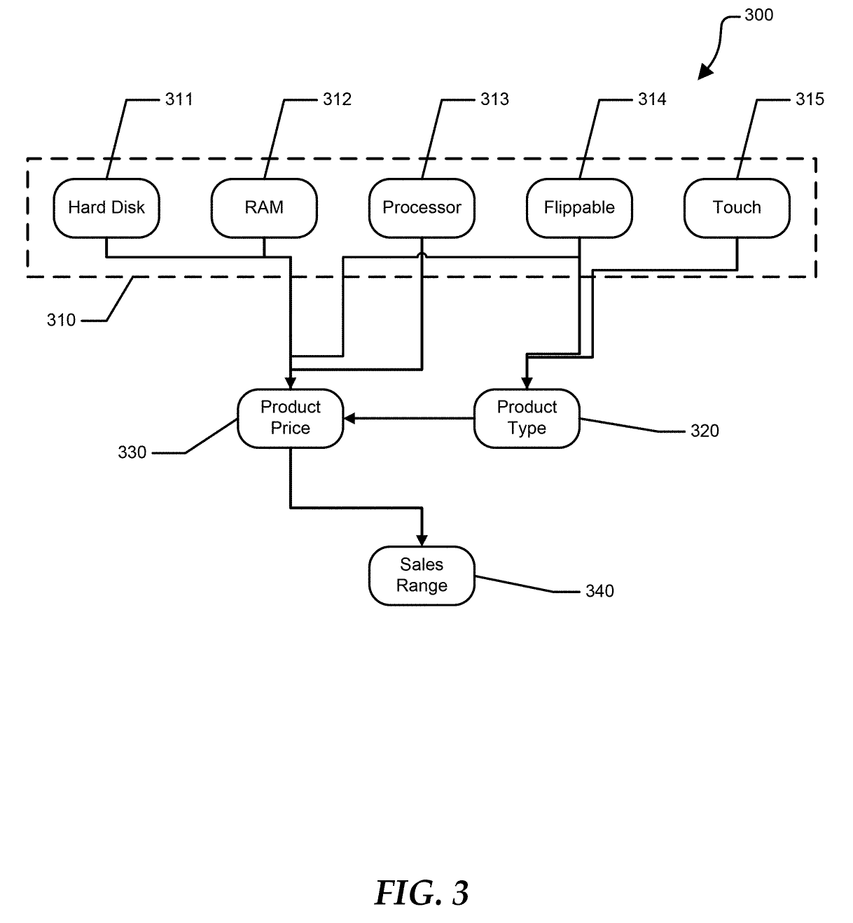

FIG. 3 is a block diagram of a Bayesian model 300 according to an embodiment of the present disclosure. In this diagrammatic example, Bayesian model 300 is constructed to be applied to computer products. Bayesian model 300 includes feature nodes 310: namely, hard disk node 311, random access memory (RAM) node 312, processor node 313, flippable node 314, and touch node 315. Hard disk node 311 represents a feature of the hard disk, for example, size, or type. RAM node 312 represents a feature of the RAM, for example, the size or type. Processor node 313 represents a feature of the processor, for example, the type, speed, or processing capacity. Flippable node 314 indicates whether a display screen is a ‘flippable’ type of display that may be flipped in position relative to a base plane. That is, flippable node 314 indicates whether the computer product has a flippable display feature. Touch node 315 indicates whether the display is a touch type display. That is, touch node 315 indicates whether the computer product has a touch screen display feature. Feature nodes 310 affect product type node 320, which represents a product type, and product price node 330, representing a product price, which in turn affects sales range node 340, as illustrated by the directional arrows. A Bayesian model may be constructed for each product or type of product for which it is desired to extrapolate a sales forecast with a set of feature nodes representing a set of features of the product.

In order to use a Bayesian model to extrapolate a sales forecast for a new product, sales data regarding other products with shared or similar features to the new product may be clustered. The clustered data may then be fed to an appropriately constructed Bayesian model with a set of feature nodes corresponding to the features of the new or proposed product. In order to efficiently extrapolate sales forecasts for a new or proposed product, the clustering used to derive a data cluster from sales data should be computationally efficient.

Clustering in data mining has been of importance for various tasks like discovering patterns in the dataset, understanding the structure of the dataset and many others. Clustering is a technique to group data with similar characteristics. Today much of the data like product data, customer purchase data, marketing data, social media data and many other such data that contains information of a domain are in the form of categorical datasets or text datasets. Traditional clustering algorithms like k-means clustering algorithms are productive with numerical data in which each cluster has a mean and the algorithm minimizes the sum of squared distance between each data point to its closest center. Since k-means algorithm works by finding the mean which requires numerical data type, the algorithm cannot be implemented on categorical dataset where the data is nominal. Clustering algorithms designed to cluster categorical dataset like k-modes clusters data points based on the selection of initial modes. The clustering in k-modes highly depends on the selection of initial modes and is also sensitive to outlying data points. Clustering algorithms based on the computation of pairwise similarity of the datasets such as spectral clustering have gained a lot of importance because of their simplicity and effectiveness in finding good clusters.

Clustering generally suffers from problems in that selection of centroids for individual clusters may be problematic and outlying data points may mar clustering quality. Random initialization of centroids may require multiple clustering runs to arrive at a good set of clusters.

Furthermore, clustering generally encounters two problems when applied to large datasets: (1) the memory problem: clustering requires the computation and storage of a corresponding large similarity matrix, and (2) the time efficiency problem: clustering requires the computation of eigenvectors which runs in quadratic time. The memory constraint of storing the large similarity matrix can be mitigated by sparsifying the similarity matrix. The time constraint can be mitigated to an extent by using fast Eigensolvers and running the algorithm in parallel across multiple machines. A simple spectral clustering algorithm may then use basic k-means to cluster the transformed reduced space. A categorical dataset may be reduced by constructing the similarity matrix using a Jaccard similarity coefficient. By leveraging the information in the similarity matrix, initial centroids may be calculated to mitigate effects of outlying data points and perform clustering with canopy that reduces the overall time taken by the k-means algorithm.

It is desirable to get a good cluster in a single run of clustering. To this end, a pair-wise similarity approach may be used to establish relationship between two rows in a dataset. The similarity approach may be based on a Jaccard similarity coefficient. The similarity between two rows will be a numerical value ranging from 0 to 1.

The data points are plotted into higher dimensional space where the inter cluster space is expected to be less and intra cluster space is expected to be more.

The categorical data is converted into numerical values using smart similarity measure based on threshold provided which can be leveraged to reduce the dimensions of the overall datasets into 2D or 3D. The 2D or 3D dataset can be visualized, and a high level understanding of the data-set gained.

The computation of similarity between data sets and selection of initial centroids may be leveraged to reduce the overall time taken to cluster the dataset.

For example, when extrapolating sales forecasts for a new computer device product, to develop a data cluster to be processed by a corresponding Bayesian model, sales data for different computer device products with one or more features in common with the new computer device product may be obtained. The sales data for the computer device products may be organized in a matrix. The matrix of sales data may then be reduced using a Jaccard similarity coefficient between different products. The reduced matrix may further be reduced using matrix eigenvectors. Then clustering operations may be performed on the matrix.

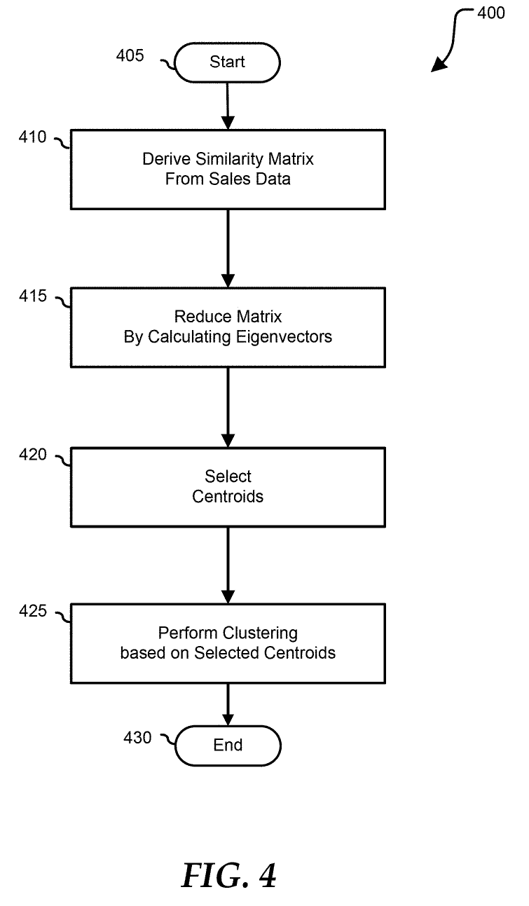

FIG. 4 is a flow diagram 400 illustrating a clustering mechanism for clustering data in a dataset. At 405, the clustering mechanism begins. At 410, a similarity matrix is derived from sales data for existing products. At 415, the similarity matrix is reduced by calculating eigenvectors of the similarity matrix. At 410, one or more data points representing one or more products are selected as centroids. At 425, clustering of data points is performed based on the selected centroids. At 430, the clustering mechanism ends.

Deriving the Similarity Matrix:

For a given dataset X={X₁,X₂, . . . Xₘ} in R^{d} where d is the number of features of the categorical dataset. The similarity between any two rows is defined by Jaccard similarity coefficient.

$$S ( {X}_{i} , {X}_{j} ) = \frac{{X}_{i} ⋂ {X}_{j}}{{X}_{i} ⋃ {X}_{j}} for i = \{ 1 , 2 , 3 … m \} \& \\ j = \{ 1 , 2 , 3 , … m \} \qquad Eq . 1$$

The Jaccard similarity between any two rows Xᵢ and Xⱼ of the dataset would be a numerical value in the range of 0 to 1. For any pair of rows Xᵢ and Xⱼ the similarity function S(Xᵢ,Xⱼ) is a function where S(Xᵢ,Xⱼ)=S(Xⱼ,Xᵢ) thus making the similarity matrix S ∈ R^{m×m} symmetric. The similarity matrix S^{m×m} is a dense matrix. For large datasets the similarity matrix would require huge memory for storage, therefore the matrix S^{m×m} is modified to be a sparse matrix S^{t×3} by zeroing out the similarity value where the Jaccard similarity coefficient is less than a specified similarity threshold (θ)

S(Xᵢ,Xⱼ)=0 if S(Xᵢ,Xⱼ)<θ Eq. 2

The sparse similarity matrix S^{t×3} consumes less space when compared to the similarity matrix S^{m×m} where t is the number of non-zero elements in the similarity matrix. The overall cost incurred to construct the sparse similarity matrix is O(n²d)

Dimension Reduction and Data Compression:

The similarity matrix is a m×m matrix where the dimensions are high for a large dataset and the corresponding computational cost of running an algorithm over such high dimensional matrix is high. Therefore the dimensions of the similarity matrix Sᵢⱼ are reduced while retaining as much data as possible. Many dimensions (for example, columns) in the similarity matrix may be highly correlated; in such a case retaining all the dimensions would be paltry. Dimensional reduction works on the principal of finding a subspace where the variance in the dataset is maximum. The data are projected into this subspace by taking the dot product of the similarity matrix Sᵢⱼ in (m×m) and the k Eigenvectors in (m×k). The new dataset (projected dataset) may then be clustered with clustering algorithms:

Sᵢⱼ^{m×k}=Sᵢⱼ^{m×m}·A^{m×k} Eq. 3
Sᵢⱼ^{m×k} is the transformed matrix
Sᵢⱼ^{m×m} is the similarity matrix
A^{m×k} is the eigenvectors

Finding first k Eigenvectors: After obtaining the sparse matrix, sparse Eigensolvers are used to find the first k eigenvectors that point to the maximum variance of the datasets. The Eigensolvers obtain the first k eigenvectors of the similarity matrix Sᵢⱼ. Then the dot product of the first k eigenvectors in (m×k) and the similarity matrix Sᵢⱼ in (m×m) is taken and the similarity matrix is transformed into (m×k). Here k can be as small as 1 depending on the percentage of variance retained. The dimension reduction also helps in visualization of the dataset. For example, converting the dataset into 2D or 3D space while retaining crucial information about the data would help in visualizing the data.

Selecting Centroids:

Selecting a subset of data points as centroids plays a crucial role in finding clusters using a k-means algorithm. For random initialization of centroids there is a high chance of defaulting to the local minima data points, which results in bad clustering. Therefore with random initialization of centroids, k-means algorithm is required to be run multiple times with random initialization of centroid and the centroids that minimizes the sum of squared distance between the data points are selected as cluster centroids. Re-running the algorithm multiple times for a large dataset is computationally costly and the clustering quality may be low. The k-means algorithm is generally sensitive to outlying data points and generally requires the number of clusters to be specified.

In accordance with the embodiments disclosed herein, a simple approach based on the computation of pairwise similarity may be used to select a subset of data points as the initial centroids. Namely, based on a specified clustering threshold value (θ) overlapping groups are delineated with each group containing the data points that are similar to each other. Points within a group are tightly grouped. Any one element of each group is considered as the centroid of that group provided the element is not in the overlapping region.

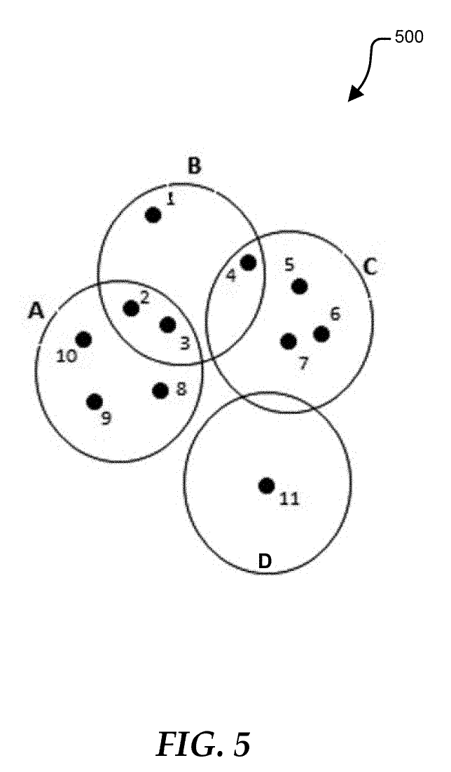

FIG. 5 illustrates a graph 500 of data points 1 to 11 scattered in 2D space: as can be seen from graph 500, there are four groups of data points: A, B, C, and D. For a given clustering threshold value (θ) the similarity for each data point can be written as:
1: [1,2,3,4]
2: [1,2,3,4,8,9,10]
3: [1,2,3,4,8,9,10]
4: [1,2,3,4,5,6,7]
5: [4,5,6,7]
6: [4,5,6,7]
7: [4,5,6,7]
8: [2,3,8,9,10]
9: [2,3,8,9,10]
10: [2,3,8,9,10]
11: [11]

Data points that are distant from other data points are considered as outlying data points. In graph 500 all data points except data point 11 are in proximity to one another; data point 11 however, is distant from the other data points and therefore can be considered an outlying data point. The selection of centroids works on the principle of choosing data points that are distant from each other and excludes data points that are tightly grouped with previously chosen centroids.

How a centroid is chosen in graph 500:
1. Data point 11 is chosen as the first centroid because point 11 has the least number of connections.
2. Data point 1 is chosen as the second centroid. Since data points 2, 3, and 4 are tightly grouped with chosen centroid data point 1, data points 2, 3, and 4 are not used in centroid assignment and therefore are skipped.
3. Data point 5 is chosen as the third centroid because data point 2, 3, and 4 are skipped. Since data points 6 and 7 are tightly grouped with the chosen centroid data point 5, data points 6 and 7 are not used in centroid assignment and therefore are skipped.
4. Data point 8 is chosen as the fourth centroid because data point 2, 3, 4, 6, and 7 are skipped. Since data points 2, 3, 9, and 10 are tightly coupled to the chosen centroid data point 8, data points 2, 3, 9, and 10 are not used in centroid assignment and therefore are skipped.
   Thus there are four clusters:
Cluster1: 11
Cluster2: 1
Cluster3: 4,5,6,7
Cluster4: 2,3,8,9,10

The above described clustering mechanism has numerous benefits. The mechanism does not require a cluster number to be specified, the number of clusters are decided implicitly by the algorithm based on the selected clustering threshold value. The above-described centroid selection mechanism mitigates skewing effects of outlying data points. The above-described centroid selection mechanism mitigates default clustering around local minimas. Experiments performed on various public datasets shows that a clustering threshold value within the range of 0.3 and 0.5 results in good clusters.

Performing K-Means on the Reduced Dimensional Space:

K-means is a widely used clustering algorithms for variety of tasks like preprocessing the dataset or finding patterns in the underlying data. K-means partitions the datasets by minimizing the sum of squared distance between each data point to its nearest cluster. The algorithm is an iterative process that operates by calculating the Euclidean distance between all the data points and chosen centroids.

For a given matrix X ∈ R^{m×d}, where m is the number of rows and d is the number of dimensions of the reduced similarity matrix Sᵢⱼ. For centroids c={c₁,c₂, . . . cₖ} the k-means is defined as:

$${\sum }_{i = 1}^{k} {\sum }_{{X}_{j} ∈ {c}_{i}} {‖ {X}_{j} - {c}_{i} ‖}^{2} for j = \{ 1 , 2 , … m \} \qquad Eq . 4$$

For a very large dataset the computation of distance between each of the data points and the centroids can be computationally expensive. Therefore the distance between centroids and the data points are computed only for the data points in the group to which the centroid belongs. Data points belonging to different groups are assumed to be far from each other. In graph 500 of FIG. 5 it is highly unlikely that points 1 and 10 or points 1 and 7 would fall under the same cluster. For a data point in group A of graph 500, the distance of the centroid would only be computed for data points 2,3,8,9, and 10, as those are the constituent data points of group A.

From the initial centroids selection it is ensured that each group is assigned a centroid which is a data point in that group. So it is highly unlikely that the centroids belonging to a group would move entirely to another group, however the centroid may move to the overlapping region at times when data points in the overlapping region are much larger when compared to data points in non-overlapping region. The above-described clustering mechanism still ensures that all the data points are covered and clustered.

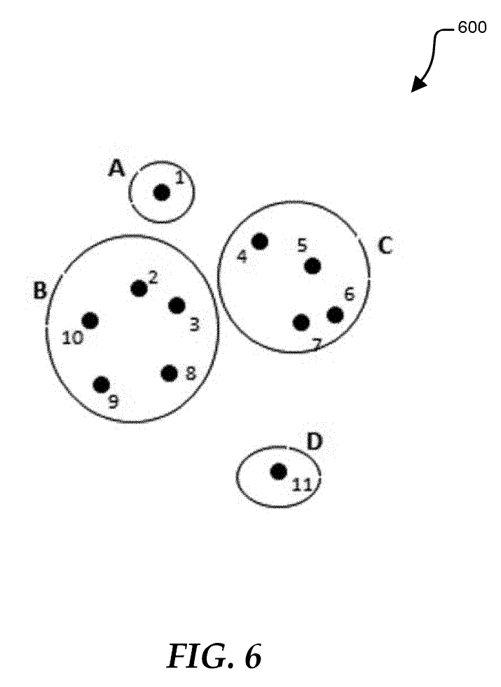

FIG. 6 illustrates a graph 600 of clusters of data points. Namely, clusters A, B, C, and D have been formed, clusters A, B, C, and D together subsuming data points 1 to 11, as shown. Cluster A consists of or comprises data point 1; cluster B consists of or comprises data points 2, 3, 8, 9, and 10; cluster c consists of or comprises data points 4-7; and cluster D consists of or comprises data point 11.

Thus, one or more clusters will be formed from the clustering mechanism based on product features, type of customers, location of sale of product, sales channels and other properties associated with the product. The cluster of data points representing existing products with features most similar to the new or proposed product is fed to the Bayesian model, and the output of the Bayesian model provides a sales forecast based on the cluster, which then may be refined with regression techniques, such as linear regression to further refine the sales forecast by providing a sales granularity.

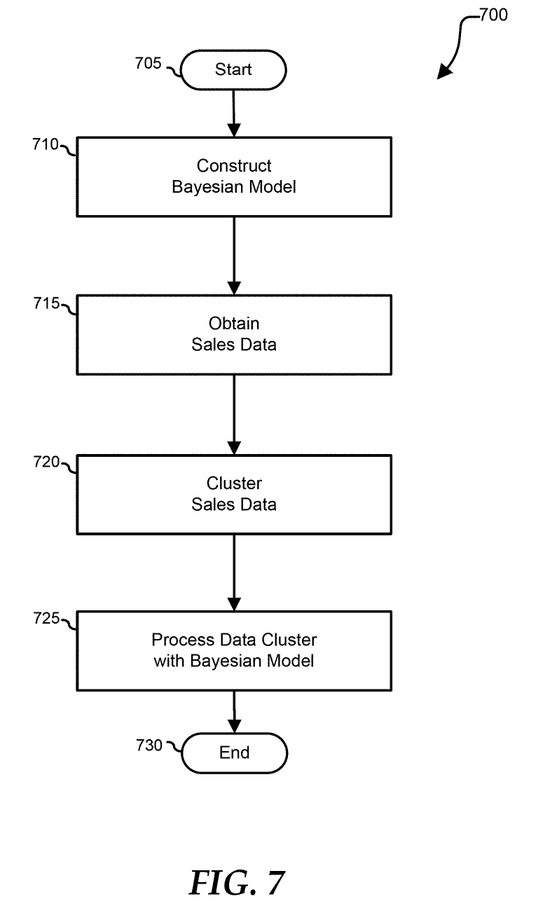

Using above-described techniques, sales forecasts for a new product may be extrapolated from sales data for existing products. The products may be computer device products, for example. FIG. 7 is a flow diagram 700 of extrapolating a sales forecast using above-described techniques. At 705, the method begins. At 710, a Bayesian model is constructed to extrapolate a sales forecast for a new product. As discussed above with regard to FIG. 3, the Bayesian model with have a set of feature nodes corresponding to a set of features of the new product. Building upon the example of a computer device product, to extrapolate a sales forecast for a computer device product, a corresponding Bayesian model with be constructed with features nodes representing the features of the computer device product, such as memory features, microchip features, and other computer device features. Each feature node in the Bayesian model will be associated with a probability. The probability may be determined based on a number of computer device products sold which include the feature divided by the total number of computer device products sold. An information handling system such as that illustrated in FIG. 2 may be used to construct the Bayesian model.

Once the Bayesian model for a new product has been constructed at 710, at 715, sales data for a set of products with one or more features in common with the features of the new product is obtained. For example, continuing to build upon the example of a computer device product, to extrapolate a sales forecast for a new computer device product, sales data for existing computer device products with one or more features in common with the new computer device product may be obtained. The sales data may also be weighted by assigning different weights to different features, depending upon the presumed desirability of the features to a sales demographic.

The sales data obtained at 715 may be clustered to generate a data cluster at 720. The sales data may be clustered as described above with regard to FIG. 4. For example, the sales data may be compiled into a similarity matrix. Continuing to build upon the example of a computer device product, sales data obtained for existing computer device products may be compiled into a matrix with rows of the matrix corresponding to existing computer device products. The rows may be collapsed based on a similarity coefficient between the rows, for example, a Jaccard similarity coefficient, thereby resulting in a sparse similarity matrix. The matrix may further be reduced by calculating one or more eigenvectors of the matrix and using the calculated eigenvectors to reduce the dimensions of the matrix.

Then, data points are selected as centroids, and data points are grouped with regard to the selected centroids based on a specified clustering threshold. The data points are clustered together based on the selected centroids, and data clusters are formed. Continuing to build upon the example of a computer device product, clustering as applied to computer device product sales data will produce data clusters of sales data for sets of similar computer device products. The data cluster for the set of clustered computer device products most similar to the new computer device product is selected. For example, if the new computer device product is to be a laptop computer, the selected data cluster may be for a set of existing laptop computers with one or more features in common with the new laptop computer.

Subsequent to clustering sales data and selecting a data cluster, at 720, at 725, the data cluster is processed with the Bayesian model and the Bayesian model generates a sales forecast from the selected data cluster. As discussed above, linear regression techniques may be applied to the sales forecast generated by the Bayesian model to further refine the sales forecast.

Computer code executable to implement embodiments of above-described techniques and methods may be stored on computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
clustering a set of sales data for a set of products having a first set of features into a first cluster;
storing the first cluster in an electronic memory; and
processing the first cluster with a Bayesian model including one or more feature nodes representing one or more features of the first set of features, wherein the one or more nodes represent one or more features of a first product, the first product distinct from products of the set of products.

2. The method of claim 1, further comprising processing the output of the Bayesian model with Linear regression.

3. The method of claim 1, wherein each feature node of the one or more feature nodes is associated with a respective probability.

4. The method of claim 1, wherein clustering the set of sales data comprises deriving a similarity matrix from the set of sales data using a Jaccard similarity coefficient.

5. The method of claim 4, wherein clustering the set of sales data comprises calculating a first eigenvector of the similarity matrix and reducing the similarity matrix using the first eigenvector.

6. The method of claim 5, further comprising selecting a first data point in the reduced similarity matrix as a centroid of the first cluster.

7. The method of claim 6, further comprising grouping data points with regard to the centroid based on a clustering threshold.

8. The method of claim 7, further comprising clustering the first cluster with regard to the centroid.

9. A non-transitory computer readable medium storing instructions that, when executed by a processor, cause the processor to:
cluster a set of sales data for a set of products having a first set of features into a first cluster; and
process the first cluster with a Bayesian model comprising one or more feature nodes representing one or more features of the first set of features, wherein the one or more feature nodes represent one or more features of a first product, the first product distinct from products of the set of products.

10. The non-transitory computer readable medium of claim 9, storing further instructions, that when executed by the computer, cause the computer to process the output of the Bayesian model with Linear regression.

11. The non-transitory computer readable medium of claim 9, wherein each feature node of the one or more feature nodes is associated with a respective probability.

12. The non-transitory computer readable medium of claim 9, wherein clustering the set of sales data comprises deriving a similarity matrix from the set of sales data using a Jaccard similarity coefficient.

13. The non-transitory computer readable medium of claim 12, wherein clustering the set of sales data comprises calculating a first eigenvector of the similarity matrix and reducing the similarity matrix using the first eigenvector.

14. The non-transitory computer readable medium of claim 13, storing further instructions, that when executed by the computer, cause the computer to select a first data point in the reduced similarity matrix as a centroid of the first cluster.

15. The non-transitory computer readable medium of claim 14, storing further instructions, that when executed by the computer, cause the computer to group data points with regard to the centroid based on a clustering threshold.

16. The non-transitory computer readable medium of claim 15, storing further instructions, that when executed by the computer, cause the computer to cluster the first cluster with regard to the centroid.

17. An information handling system comprising:
a memory; and
a processor configured to:
derive a similarity matrix from a set of sales data for a set of products having a first set of features using a Jaccard similarity coefficient;
calculate a first eigenvector of the similarity matrix and reducing the similarity matrix using the first eigenvector;
select a first data point in the reduced similarity matrix as a centroid for a first cluster;
group data points with regard to the centroid based on a clustering threshold;
cluster the first cluster with regard to the centroid; and
process the first cluster with a Bayesian model comprising one or more feature nodes representing one or more features of the first set of features, wherein the one or more nodes represent one or more features of a first product, the first product distinct from products of the set of products.

18. The information handling system of claim 17, further comprising processing the output of the Bayesian model with Linear regression.

19. The information handling system of claim 17, wherein each feature node of the one or more feature nodes is associated with a respective probability.

20. The information handling system of claim 17, further comprising weighting a feature represented by a feature node of the one or more feature nodes.
